(19) United States
(12) Patent Application Publication
(10) Pub. No.: US 2013/0153007 A1
(43) Pub. Date: Jun. 20, 2013

(54) TORQUE TUBE WITH OUTRIGGER

(71) Applicant: Adam Plesniak, Seal Beach, CA (US)

(72) Inventor: Adam Plesniak, Seal Beach, CA (US)

(21) Appl. No.: 13/708,894

(22) Filed: Dec. 7, 2012

Related U.S. Application Data
(60) Provisional application No. 61/570,727, filed on Dec. 14, 2011.

(51) Int. Cl. H01L 31/042; H01L 31/18

(52) U.S. Cl. CPC H01L 31/0422; H01L 31/18
USPC 136/251; 29/890.033

(57) ABSTRACT

Systems and methods may be provided for supporting a solar module. A torque tube may be provided with one or more longitudinal outrigger extensions which may extend beyond an end of the torque tube. In some embodiments, the torque tube does not extend all the way to the edge of the solar module.

### CROSS-REFERENCE

This application claims priority to U.S. Provisional Patent Application Ser. No. 61/570,727, filed on Dec. 14, 2011, which is entirely incorporated herein by reference.

### BACKGROUND OF THE INVENTION

Solar panels convert sunlight energy into electrical energy. As such, they can potentially compete with conventional methods of electricity generation, such as, for example, steam turbine generators fueled by coal, nuclear fuel, or natural gas.

In order for solar energy to compete on a large scale with conventional electricity generation, the cost of solar energy systems should be reduced. Such cost reduction should be made while still meeting structural requirements. Traditional solar modules are typically supported by tubes that extend along the entire length of the solar module. Such tubes are typically costly. Additionally, transport of such tubes is often complicated and costly due to its size.

Thus, a need exists for solar module support structures that reduce cost over typical full-length torque tubes.

### SUMMARY OF THE INVENTION

Systems and methods may be provided for supporting a solar module. A torque tube may be provided with one or more longitudinal outrigger extensions which may extend beyond an end of the torque tube. In some embodiments, the torque tube does not extend all the way to the edge of the solar module.

An aspect of the invention is directed to a solar arrangement comprising: a solar module having a plurality of photovoltaic cells; a torque tube, wherein an end of the torque tube does not extend to an edge of the solar module; and at least one outrigger connected to the torque tube and the solar module, wherein the at least one outrigger extends beyond the end of the torque tube toward the edge of the solar module.

Another aspect of the invention provides a method of supporting a solar module having at least one photovoltaic cell, said method comprising: providing a torque tube that supports the solar module, wherein an end of the torque tube does not extend to an edge of the solar module; and providing at least one outrigger connected to the torque tube and the solar module, wherein the at least one outrigger extends beyond the end of the torque tube toward the edge of the solar module.

A solar arrangement is provided in accordance with an additional aspect of the invention. The solar arrangement may comprise: a solar module having a plurality of photovoltaic cells; a torque tube, wherein a length of the torque tube along a longitudinal axis is less than a length of the solar module parallel to the longitudinal axis of the torque tube; and at least one outrigger connected to the torque tube and the solar module, wherein the at least one outrigger extends beyond the end of the torque tube and is not perpendicular to the longitudinal axis of the torque tube.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a torque tube provided in accordance with an embodiment of the invention.

FIG. 2 shows an example of a torque tube without longitudinal outrigger extensions.

FIG. 3 shows an example of a torque tube with longitudinal outrigger extensions, provided in accordance with an embodiment of the invention.

FIG. 4 shows an example of an end of the torque tube with outriggers.

FIG. 5 shows an example of a torque tube without longitudinal outrigger extensions attached to a solar module.

FIG. 6 shows an example of a torque tube with longitudinal outrigger extensions attached to a solar module, in accordance with an embodiment of the invention.

FIG. 7 shows a view of the outriggers attached to the solar module, in comparison with a full-length torque tube.

FIG. 8 shows an example of how the outriggers may be affixed to a plate that may separate portions of the torque tube.

FIG. 9 shows a solar module, including a support with a torque tube with longitudinal outrigger extensions.

### DETAILED DESCRIPTION OF THE INVENTION

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for supporting solar modules in accordance with aspects of the invention. Various aspects of the invention described herein may be applied to any of the particular applications set forth below or for any other types of photovoltaic and/or concentrated photovoltaic applications. The invention may be applied as a standalone system or method, or as part of a renewable energy package, or support system. It shall be understood that different aspects of the invention can be appreciated individually, collectively, or in combination with each other.

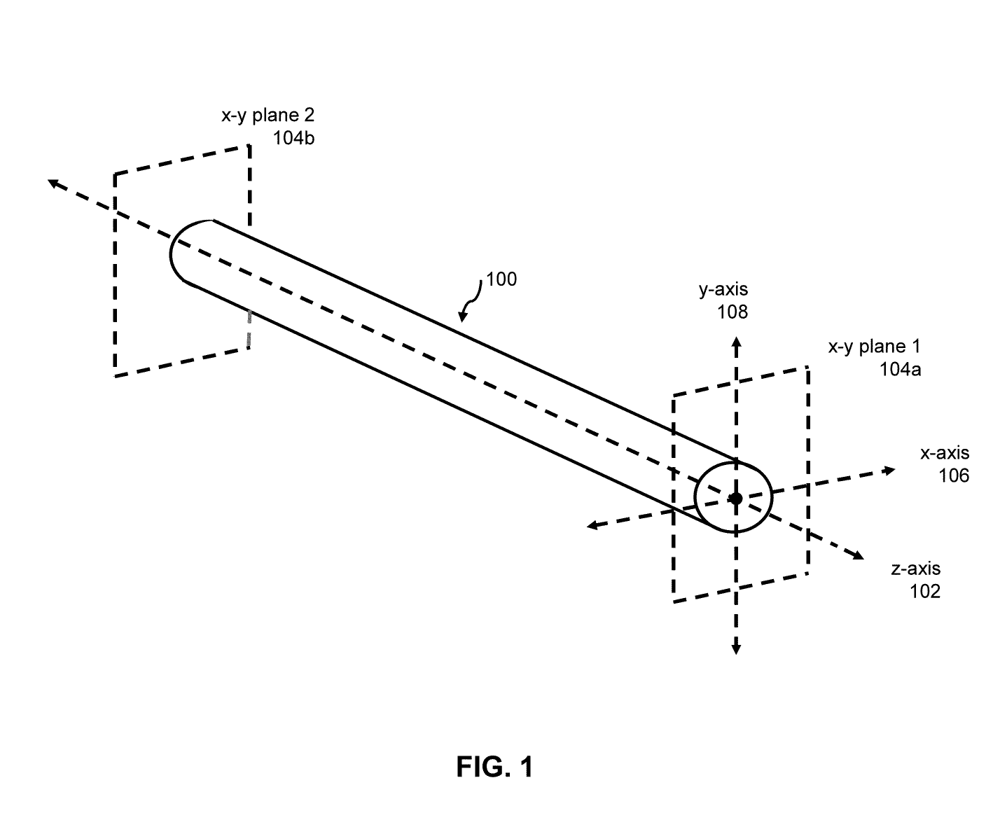

FIG. 1 shows an example of a torque tube 100 provided in accordance with an embodiment of the invention. The torque tube may support a solar module. In some instances, the torque tube may be connected to a solar module. The torque tube may be connected to the solar module via one or more outriggers or other structures. The solar module may be movable relative to the torque tube. For example, the solar module may rotate about a longitudinal axis of the torque tube. Alternatively, the solar module may remain stationary relative to the torque tube.

The torque tube may have a longitudinal axis 102 extending therethrough. The longitudinal axis may be a z-axis of the torque tube. The torque tube may rotate about the longitudinal axis. Alternatively, the torque tube may remain stationary relative to the longitudinal axis.

The torque tube may have one or more ends. In some instances, the torque tube may have two ends. The torque tube may extend longitudinally between the ends. In some instances, the ends of the torque tubes may be delineated by x-y planes 104a, 104b. For example, a first end of the torque tube may be delineated by x-y plane 1 104a, and a second end of the torque tube may be delineated by x-y plane 2 104b. The x-y planes may be orthogonal to the longitudinal axis 102. The x-y planes may be parallel to one another. The x-y planes may have an x-axis 106 and y-axis 108 which may be orthogonal to the z-axis and to one another.

For an object to extend beyond the length and/or end of the torque tube, the object may extend past the x-y planes at the ends of the torque tube. An object may extend beyond the length and/or end of the torque tube, if the object extends in the z-direction past the x-y plane at the end of the torque tube, whether the object extends parallel to the z-direction, or at any other angle relative to the x-direction. For example, an object extending 45 degrees relative to the longitudinal axis of the torque tube may extend beyond the end of the torque tube if the object passes beyond the x-y plane at the end of the torque tube.

The torque tube may be a solid tube or may be a hollow tube. The torque tube may have a thickness that may remain the same throughout the length of the tube. Alternatively, the thickness of the tube may vary along the length of the tube.

The torque tube may have a circular cross-section. Alternatively, the torque tube may have an elliptical cross-section, oval cross-section, triangular cross-section, quadrilateral cross-section (e.g., square, rectangular), pentagonal cross-section, hexagonal cross-section, octagonal cross-section, I- or H-shaped cross-section, T-shaped cross-section, or any other cross-sectional shape. The cross-sectional shape may remain the same throughout the length of the torque tube or may vary along the length.

The torque tube may have any diameter (or longest cross-sectional dimension). The diameter and/or dimensions of the torque tube may remain the same along the length of the torque tube, or may vary. In some instances, the torque tube may have a diameter greater than, less than, equal to one or more of the following, or falling between two or more of the following: about 1 cm, 2 cm, 3 cm, 4 cm, 5 cm, 6 cm, 7 cm, 8 cm, 9 cm, 10 cm, 11 cm, 12 cm, 13 cm, 14 cm, 15 cm, 17 cm, 20 cm, 25 cm, 30 cm, 35 cm, 40 cm, 50 cm, 60 cm, 70 cm, 80 cm, 90 cm, 100 cm, 120 cm, or 150 cm.

The torque tube may have any length. In some instances, the torque tube may have any length greater than, less than, equal to one or more of the following, or falling between two or more of the following: 20 ft, 30 ft, 35 ft, 40 ft, 45 ft, 47 ft, 50 ft, 51 ft, 52 ft, 53 ft, 55 ft, 57 ft, 60 ft, 65 ft, 70 ft, 75 ft, 80 ft, or 100 ft. In some instances, the torque tube may have a length that is about equal to or less than the length of a vehicle. Examples of such vehicles may include a standard flat bed truck, medium duty truck (e.g., class 4 truck, class 5 truck, class 6 truck), heavy duty truck (e.g., class 7 or class 8 truck), trailer, cargo container, or van.

The torque tube may have any weight. In some examples, the torque tube may weigh about 100 lbs, 200 lbs, 300 lbs, 500 lbs, 700 lbs, 800 lbs, 1000 lbs, 1500 lbs, 2000 lbs, 3000 lbs, 4000 lbs, 5000 lbs, 6000 lbs, 7000 lbs, 7500 lbs, 8000 lbs, 9000 lbs, 10,000 lbs, 12,000 lbs, 15,000 lbs, or 20,000 lbs.

The torque tube may be formed from any material. For example the torque tube may be formed from metal such as steel, iron, aluminum, titanium, silver, gold, brass, nickel, copper, or alloys or combinations thereof, or may include carbon, plastics, or composite materials, or any combinations thereof.

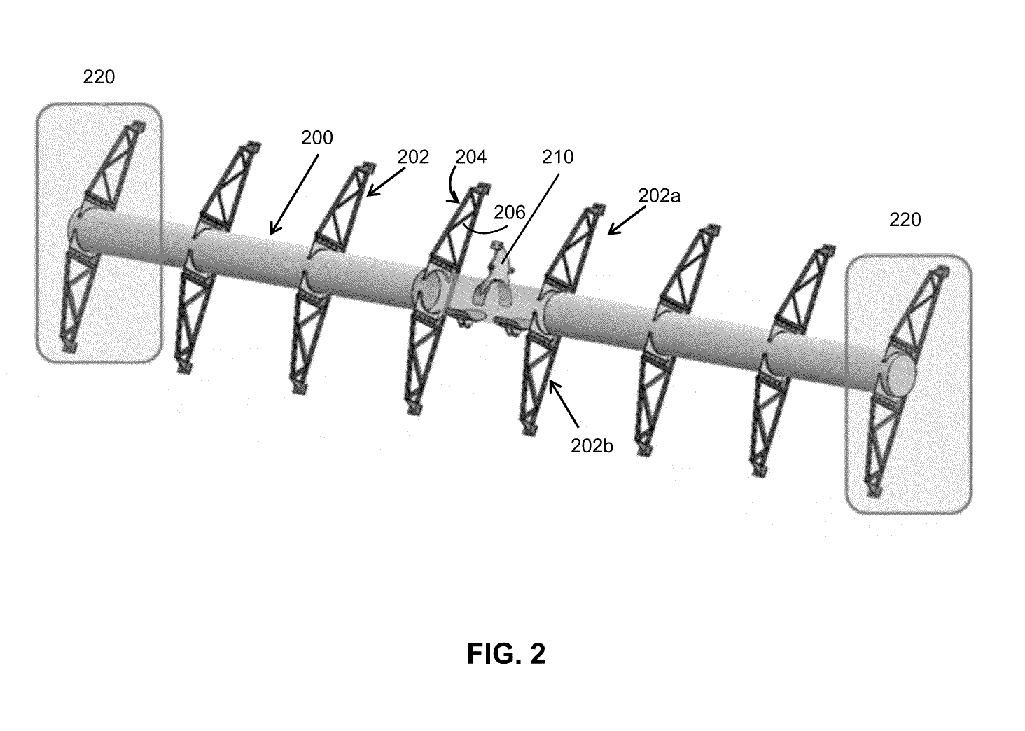

FIG. 2 shows an example of a torque tube 200 without longitudinal outrigger extensions extending past the end of the torque tube. A torque tube may be provided with one or more supports 202 along the length of the torque tube. The supports may be trusses that may include an exterior frame 204 and one or more internal supporting features 206. Any number or arrangement of internal supporting features may be provided. For example, one or more, two or more, three or more, four or more, five or more, seven or more, or ten or more internals bars, plates, and/or other features may be provided. The supports may be outriggers. In alternate embodiments, the supports may be plates, i-beams or may have any cross sectional shape including but not limited to circles, ellipses, ovals, triangles, quadrilaterals, pentagons, hexagons, octagons, H-shapes, T-shapes, C-shapes or any other shape including those described elsewhere herein. The supports may have one or more open sections that may permit wind to flow through.

The supports may extend on opposing sides of the torque tube 202a, 202b. The supports on the opposing sides of the torque tube may be symmetrical to one another. Alternatively, they may have varying configurations. The supports may extend so that they are orthogonal to the longitudinal axis of the torque tube. Alternatively, they may be at any angle relative to the longitudinal axis of the torque tube.

The supports may have any length. For example, the supports may be greater than, less than, and/or equal to about 0.1 m, 0.3 m, 0.5 m, 0.7 m, 1.0 m, 1.2 m, 1.5 m, 1.7 m, 2 m, 2.5 m, 3 m, 4 m, or 5 m in length. The ratio of the support length to the diameter of the torque tube may have any value including but not limited to about 10:1, 7:1, 5:1, 4:1, 3:1, 2:1, 1.5:1, 1:1, 1:1.5, 1:2, 1:3 or 1:5.

The supports may be provided a one or more points along the length of the torque tube. In some instances, the supports may be at one, two, three, four, five, six, seven, eight, nine, ten, eleven, twelve or more points along the length of the torque tube. The sections of torque tube between the supports may have the same length, or may have varying lengths. In some instances, the section of torque tube between the supports may be no greater than a predetermined length. For example, the predetermined length may be about 5 m, 4 m, 3 m, 2.5 m, 2 m, 1.5 m, 1 m, or 0.5 m.

A torque tube rotation feature 210 may be provided. The torque tube rotation features may permit the torque tube to connect to a base support and/or the solar module. The torque tube rotation feature may assist with permitting the rotation of the torque tube, or the rotation of a solar module about the torque tube. The torque tube rotation feature may be provided at the torque tube at or near the midpoint between the ends of the torque tube. The torque tube rotation feature may alternatively be positioned at any point along the length of the torque tube, or at multiple points along the length of the torque tube.

In some systems, outriggers may be provided so that they have not extended beyond the length of the torque tube as illustrated 220. The end-outriggers may be located at or near the end of the torque tube. In the example provided, the outriggers do not extend beyond the length of the torque tube.

In some instances, the outriggers may be formed from the same material as torque tube. Alternatively, the outriggers may be formed from a different material as the torque tube. In some examples, the outriggers may be formed from a metal such as steel (e.g., ASTM A36 or something similar), iron, aluminum, titanium, silver, gold, brass, nickel, copper, or alloys or combinations thereof, or may include carbon, plastics, or composite materials, or any combinations thereof. The outriggers may be pre-galvanized and/or cold-formed. The outriggers may be formed from the same type of material (e.g., metal) as the torque tube, or different types of materials (e.g., composite and metal).

The outriggers may be formed from any process which may be the same as or different from torque tube processes. The outriggers may be formed as a truss. Alternatively, the outriggers may be formed from stamping, sheet, folded, cast, injection molded, a composite body, or various other configurations.

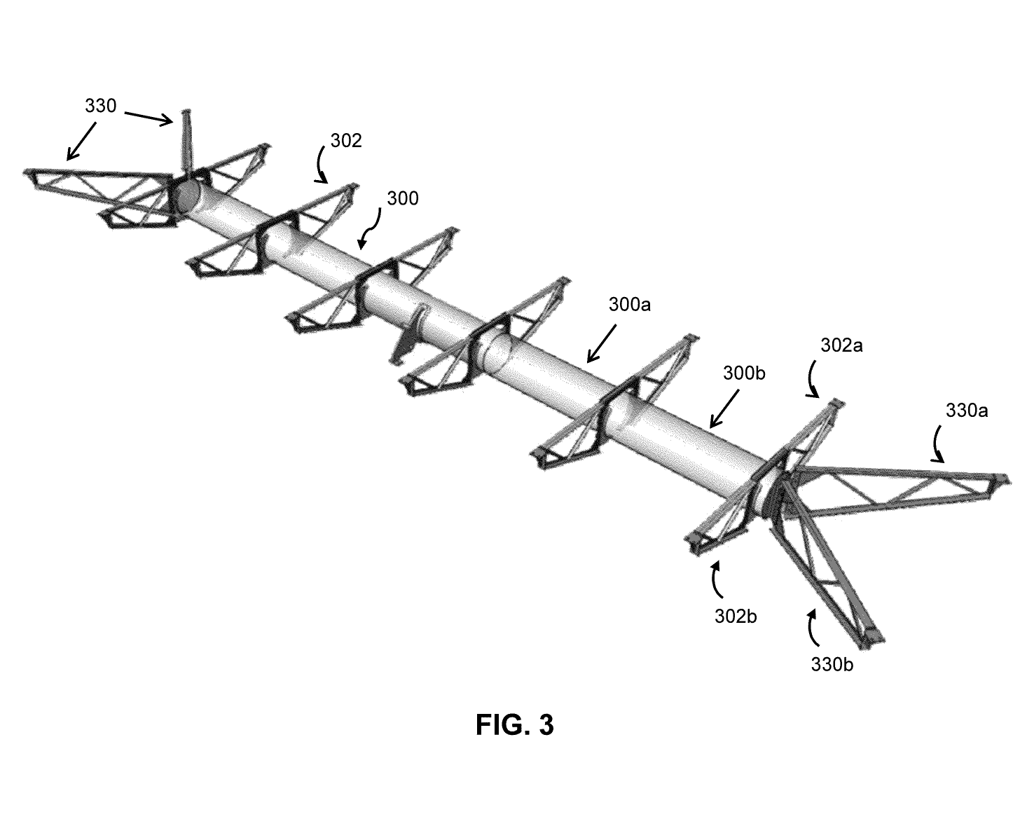

FIG. 3 shows an example of a torque tube 300 with longitudinal outrigger extensions 330, provided in accordance with an embodiment of the invention. A longitudinal outrigger extension may be a support that extends beyond the length of the torque tube.

A torque tube may have one or more supports 302 along the length of the torque tube. The supports may be provided between sections of the torque tube 300a, 300b. In some instances, the supports may be provided at or near the end of the torque tube 302a, 302b. In other instances, the supports may be middle supports, which are not at or near the ends of the torque tube. One or more outriggers extensions 330a, 330b may be a form of support that may extend beyond the length of the torque tube. The longitudinal outrigger extensions may extend beyond an x-y plane located at the end of the torque tube. The longitudinal outrigger extensions may extend at least partially along a z-axis. The longitudinal outrigger extensions may or may not be parallel to the z-axis. The longitudinal outrigger extensions may be at any angle less than 90, 80, 70, 60, 50, 45, 40, 30, 20, 10, or 5 relative to the z-axis. In some instances, the longitudinal outrigger extensions are not perpendicular to the z-axis.

The longitudinal outrigger extensions may be attached to the torque tube at or near the end of the torque tube. In some instances, being near the end of the torque tube may include being attached less than 10 cm from the end of the torque tube, less than 5 cm from the end of the torque tube, less than 3 cm from the end of the torque tube, less than 2 cm from the end of the torque tube, or less than 1 cm from the end of the torque tube. Alternatively, the longitudinal outrigger extensions may attached at any point along the length of the torque tube.

The longitudinal outrigger may extend at least partially past the end of the torque tube. In some instances, all, or substantially all, of the longitudinal outrigger may extend past the end of the torque tube. In some instances, greater than 99%, 95%, 90%, 80%, 70%, 60%, 50%, 40%, 30%, 20%, 10%, 5%, or 0% of the length of the longitudinal outrigger may extend past the end of the torque tube.

The length of the longitudinal outrigger extending past the end of the torque tube may have any ratio in relation to the length of the torque tube. For example, the ratio of the length of the longitudinal outrigger extending past the end of the torque tube to the length of the torque tube may be about 2:1, 1.5:1, 1.1:1, 1:1, 1:1.5, 1:2, 1:2.5, 1:3, 1:4, 1:5, 1:6, 1:7, 1:8, 1:9, 1:10, 1:12, 1:15, 1:20, 1:25, 1:30, 1:40 or 1:50. In determining such a ratio the length of the longitudinal outrigger extending past the end of the torque tube may be measured in a direction parallel to the length of the longitudinal outrigger, or parallel to the length of the torque tube.

In some instances, the longitudinal outrigger extension 330 may have the same length and/or configuration as supports extending along the length of the torque tube 302. Alternatively, the longitudinal outrigger extensions may have different lengths and/or configurations from the supports. In some embodiments, the longitudinal outrigger extensions may be longer than the supports, shorter than the supports, or may have the same length as the supports. The longitudinal outrigger extensions may have more internal supporting features, fewer internal supporting features, or the same number of internal supporting features as the supports.

The longitudinal outrigger extension may be formed from the same material as the torque tube and/or the supports. Alternatively, the longitudinal outrigger extension may be formed from a different material as the torque tube and/or supports. For example, the longitudinal outrigger extension may be formed from the same material as the supports and a different material from the torque tube. In another example, the longitudinal outrigger extension may be formed from a different material from the supports and a different material from the torque tube. In some examples, the longitudinal outrigger extension may be formed from a metal such as steel (e.g., ASTM A36 or something similar), iron, aluminum, titanium, silver, gold, brass, nickel, copper, or alloys or combinations thereof, or may include carbon, plastics, or composite materials, or any combinations thereof. The longitudinal outrigger extensions may be pre-galvanized and/or cold-formed.

One or more longitudinal outrigger extensions extending beyond an end of a torque tube may be provided at a single end of the torque tube. Alternatively, one or more longitudinal outrigger extensions extending beyond an end of the torque tube may be provided at two or more ends of the torque tube. One or more longitudinal outrigger extensions extending beyond an end of the torque tube may be provided at each end of the torque tube.

In some examples, a single longitudinal outrigger extension may be provided at an end of the torque tube. Alternatively, two, three, four, five, six or more longitudinal outrigger extensions may be provided at an end of the torque tube. The longitudinal outrigger extensions may be arranged symmetrically about a plane extending through the length of the tube. For example, the longitudinal outrigger extensions may be symmetrical about a y-z plane formed by a y-axis and z-axis of the torque tube. Alternatively, the longitudinal outrigger extensions may be arranged in any manner which need not be symmetrical. The longitudinal outriggers may be provided radially equidistant from one another and any end-supports. Alternatively, they need not be radially equidistant.

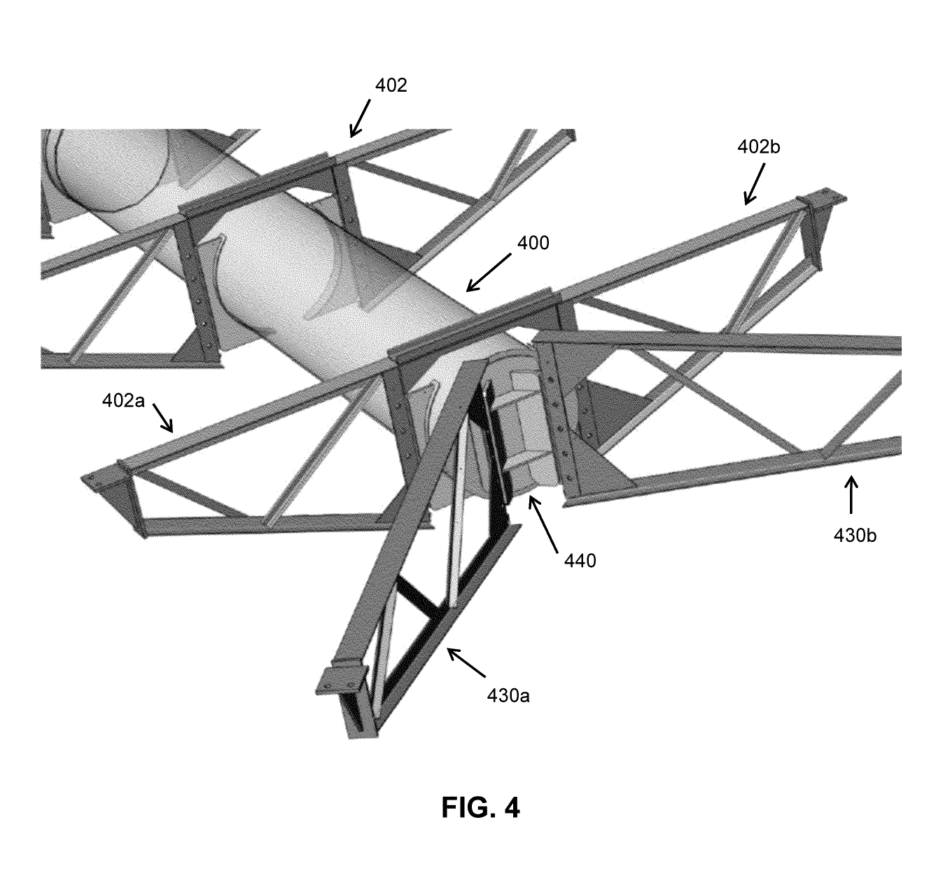

FIG. 4 shows an example of an end of the torque tube 400 with outrigger extensions 430a, 430b. One or more supports 402 may be provided along the length of the torque tube. In some instances, one or more supports 402a, 402b may be provided at or near an end of the torque tube.

The outrigger extensions 430a, 430b may extend beyond the end of the torque tube 400. The outrigger extensions may extend at fixed angles with respect to a longitudinal axis of the torque tube. Alternatively, the outrigger extensions may be pivotable so that their angle with respect to the longitudinal axis of the torque tube.

One or more end-support structure 440 may be provided which may support the outrigger extensions 430a, 430b. The outrigger extensions may or may not directly contact the torque tube 400. The outrigger extensions may be connected to the torque tube via the end-support structure. The end-support structure may be an integral part of the torque tube or may be attached to the torque tube. The end-support may or may not cover the entire end of the torque tube. The end-support structure may include only fixed pieces and may support the outrigger extensions in a fixed manner. Alternatively, the end support structure may include one or more movable part. In some instances, the movable part may permit the outrigger extensions to pivot or move.

In some embodiments, an entire length of the outrigger extension may be beyond the end of the torque tube. The outrigger extension may be connected to the torque tube at or beyond the length of the torque tube. An end-support 402a, 402b may be provided at or near the end of the torque tube. The outrigger extension may be connected to the torque tube further at or beyond the length of the torque tube relative to the support. The portion of the outrigger extension closest to the torque tube may be further from the center of the torque tube, than the portion of the support that is closest to the torque tube.

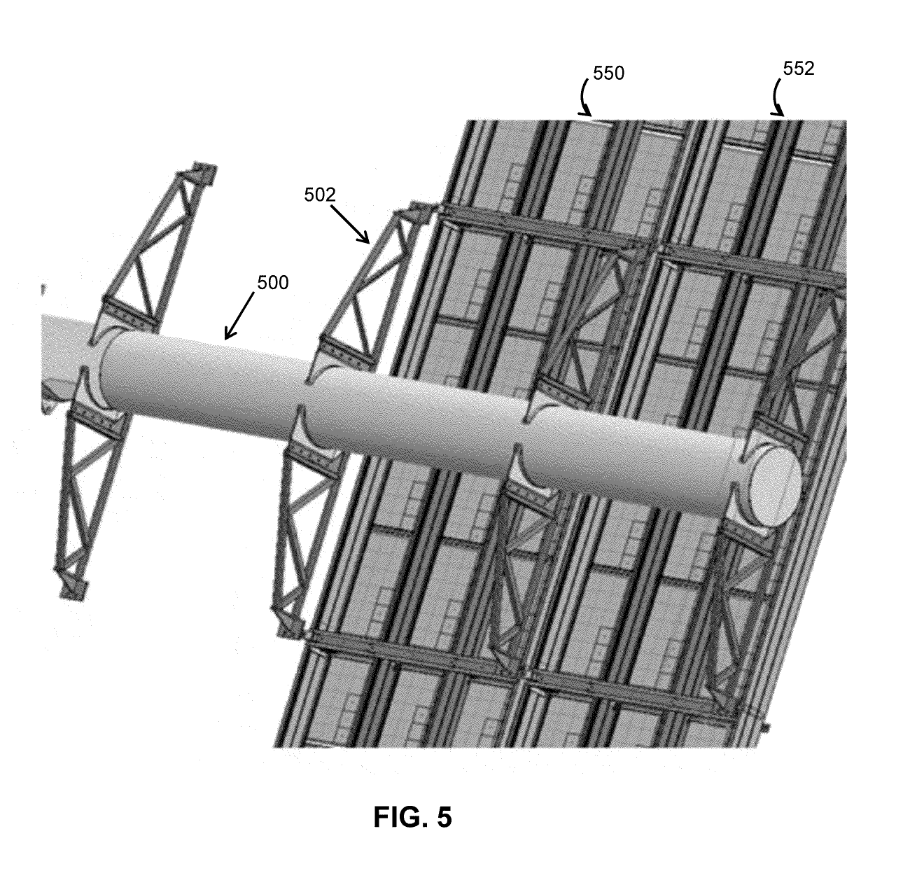

FIG. 5 shows an example of a torque tube 500 without longitudinal outrigger extensions extending past the end of the tube, attached to a solar module 550. One or more supports 502 may extend from the torque tube and connect to the solar module. The supports may directly contact the solar module. Alternatively, the supports may be connected to the solar module via one or more connection mechanism. The torque tube and one or more supports may support the solar module.

The solar module 550 may have one or more solar cells. A plurality of photovoltaic cells may be provided on a solar module. The photovoltaic cells may form an array. An array may have m rows and n columns, wherein m, n are any whole number greater than 1. The photovoltaic cells may be supported by a substrate. The photovoltaic cells may or may not be spaced apart from one another on the substrate. One, or a plurality of substrates, may be provided for a solar module. In some instances, the substrate may be a printed circuit board. The solar cells may be mounted on a printed circuit board. One or more electrical connections may be provided between the solar cells.

In some embodiments, one or more optical element may be provided for a solar module. The optical element may be a concentrating optic. The solar module may utilize concentrated photovoltaics (CPV). Examples of optics may include optically transmissive, refractive, reflective, diffractive, and/or polarizing elements. Optical elements may include lenses, mirrors, prisms, filters, or any other optical element known in the art. A single optical element may be utilized to concentrate light on a single photovoltaic cell or a plurality of photovoltaic cell. In some instances, a plurality of optical elements may concentrate light on a single photovoltaic cell or a plurality of photovoltaic cells.

In some instances, a tunnel-like or tower member may be provided over one or more photovoltaic cell. Any other support structure may be provided over the photovoltaic cell. An optical element may be provided within the tower or at the end of the tower. The optical element may be provided at a location at some distance from the photovoltaic cell. The distance may be fixed or may be variable. The optical element may move closer or further away from the cell. In some instances, the optical element may move in a telescopic fashion relative to the support structure provided over the photovoltaic cell.

A solar module, or section or component of a solar module, may have one or more characteristic, features, components, or may utilize methods of one or more of the following: U.S. Pat. No. 6,020,555; U.S. Pat. No. 8,026,440; U.S. Pat. No. 7,877,937; U.S. Pat. No. 6,248,949; U.S. Pat. No. 6,123,067; U.S. Pat. No. 6,559,371, which are hereby incorporated by reference in their entirety.

One or more supporting frame or structure 552 may be provided for the solar module. In some instances, the photovoltaic cells may be supported on one or more substrate. One or more frames may be provided that may divide sections of the solar module and/or provide support. One or more frames may support one or more substrate. The frames may enable sections of the solar modules to connect to one another. A frame may surround the entire solar module.

One or more support 502 may be connected to the solar module via a frame and/or support 552 of the solar module. A support may be arranged parallel to a portion of a frame or support of the solar module.

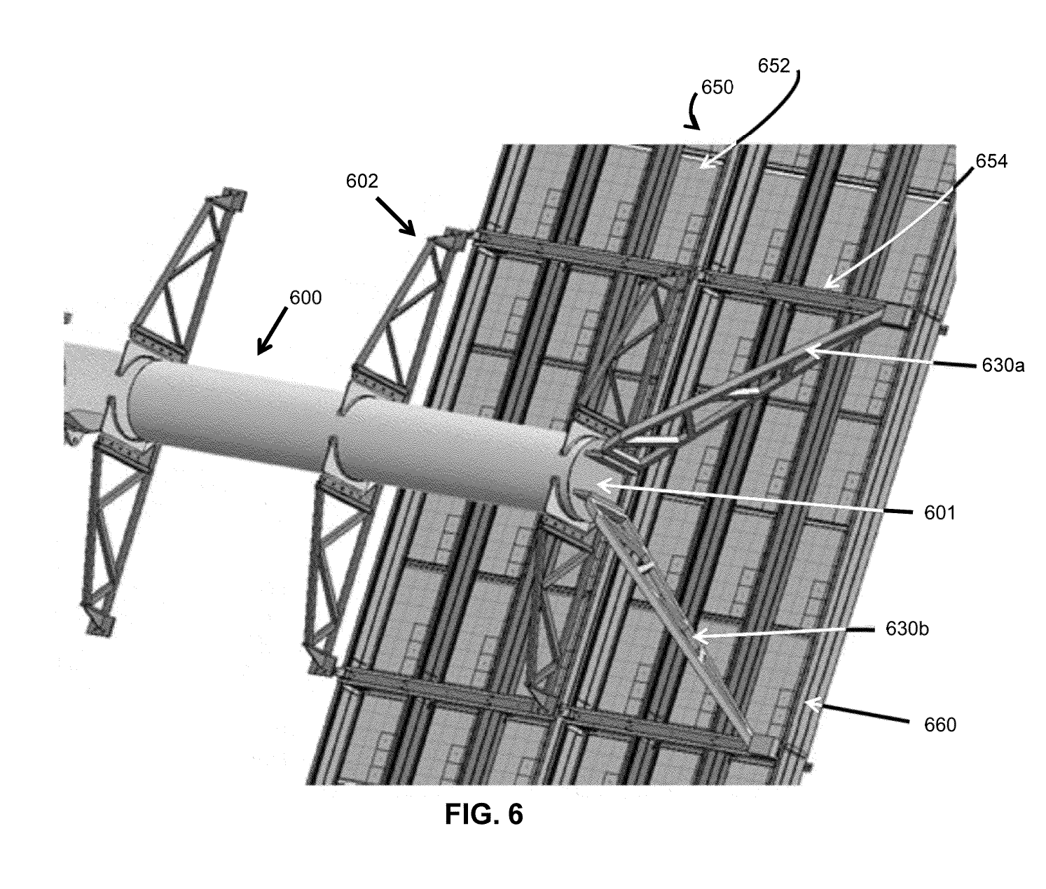

FIG. 6 shows an example of a torque tube 600 with longitudinal outrigger extensions 630a, 630b attached to a solar module 650, in accordance with an embodiment of the invention. One or more supports 602 may extend from the torque tube and connect to the solar module. The supports may directly contact the solar module. Alternatively, the supports may be connected to the solar module via one or more connection mechanism. The torque tube and one or more supports may support the solar module.

The solar module 650 may have one or more solar cells. A plurality of photovoltaic cells may be provided on a solar module. One or more supporting frame or structure 652, 654 may be provided for the solar module. The frame or supporting structure may include one or more vertical supports 652 and/or one or more horizontal supports 654. A vertical support may be orthogonal to a longitudinal axis extending through the torque tube. A horizontal support may be parallel to the longitudinal axis extending through the torque tube. In some instances, the photovoltaic cells may be supported on one or more substrate. One or more frames may be provided that may divide sections of the solar module and/or provide support. The frames may enable sections of the solar modules to connect to one another.

One or more support 602 may be connected to the solar module via a frame and/or vertical support 652 of the solar module. A support 602 may or may not be parallel to a vertical frame/support of the solar module 652.

One or more longitudinal outrigger extension 630a, 630b may extend beyond an end 601 of a torque tube 600. The longitudinal outrigger extension may or may not be parallel to a longitudinal axis extending through the torque tube. One or more longitudinal outrigger extension may be connected to the solar module via frame and/or support of the solar module. In some instances, the outrigger extension may be connected to the solar module via a horizontal support 654. In another example, the outrigger extension may be connected to the solar module via a longitudinal support 652. In some examples, the outrigger extension may be connected to the solar module at or near a location where a horizontal support meets a longitudinal support.

A longitudinal outrigger extension may contact a solar module at a single point. Alternatively, the longitudinal outrigger extension may contact the solar module at multiple points. The longitudinal outrigger extension may contact the solar module at one or more portion of a frame and/or support of the solar module. The longitudinal outrigger extension may contact the solar module at the end of the outrigger extension. The longitudinal outrigger extension may contact the solar module at any point or points along the length of the outrigger extension. For example, the longitudinal outrigger extension may be connected to the solar module along any frame over which the longitudinal outrigger passes.

A longitudinal outrigger extension may extend to an edge 660 of a solar module. Alternatively, the longitudinal outrigger extension may extend near an edge of the solar module. In some instances, the outrigger extension may be less than about 100 cm, 70 cm, 50 cm, 40 cm, 30 cm, 25 cm, 20 cm, 15 cm, 12 cm, 10 cm, 8 cm, 5 cm, 4 cm, 3 cm, 2 cm, or 1 cm from the edge of the solar module. In some instances, at least a portion of the solar module may extend beyond the outrigger extension. For example, the outrigger extension may be greater than about 100 cm, 70 cm, 50 cm, 40 cm, 30 cm, 25 cm, 20 cm, 15 cm, 12 cm, 10 cm, 8 cm, 5 cm, 4 cm, 3 cm, 2 cm, or 1 cm from the edge of the solar module.

In some embodiments, the torque tube does not reach the edge 660 of the solar module. The torque tube may be some distance away from the edge of the solar module. For example, the torque tube may be greater than, less than, or equal to about 10 m, 7 m, 5 m, 4 m, 3 m, 2.5 m, 2 m, 1.5 m, 1 m, 70 cm, 50 cm, 30 cm, 20 cm, 15 cm, 10 cm, 5 cm, 3 cm, or 1 cm from the edge of the solar module. The length of the torque tube may be less than the length of the solar module. The ratio of the length of the torque tube to the length of the solar module may be greater than, less than, or equal to about, 1:5, 1:3, 1:2, 1:1.7, 1:1.5, 1:1.3, 1:1.2, 1:1.1, 1:1.05, 1:1.01, 1:1.005, or 1:1.001.

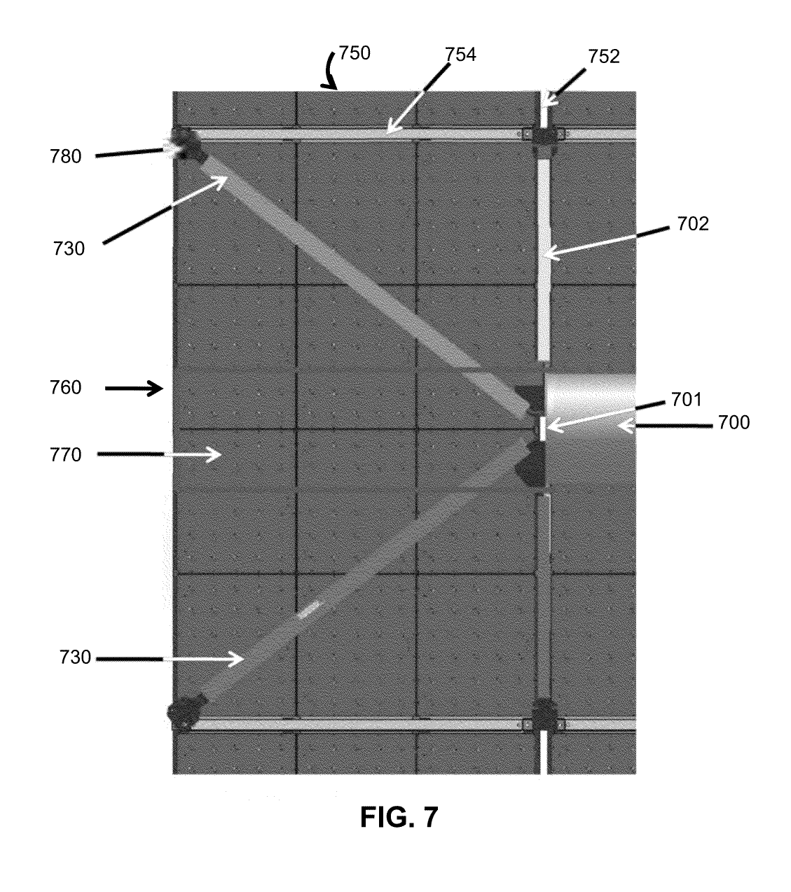

FIG. 7 shows a view of the outrigger extensions 730 attached to the solar module 750, in comparison with a full-length torque tube.

A torque tube 700 may have one or more outrigger extensions 730 extending beyond the end 701 of the torque tube. One or more support 702 may extend from a torque tube. The support may connect to a frame portion 752 of a solar module. The one or more outrigger extensions may connect to a frame portion 754 of the solar module. In some instances, they may be connected via one or more bracket 780. Any other connection mechanism known in the art may be utilized.

An outrigger extension 730 may extend toward an edge 760 of the solar module 750. The outrigger extension may terminate at or near the edge of the solar module. The outrigger extension may be at any angle with respect to a longitudinal axis extending through the torque tube. The outrigger extension may have a diagonal configuration.

The use of an outrigger extension may advantageously permit a supporting structure comprising the torque tube and outrigger extension to support a solar module while using a shorter torque tube than if the outrigger extension was not included. For example, an extended torque tube 770 that may extend to the edge 760 of the solar module may be used to support the solar module. However, by use of the outrigger extension, the torque tube length may be shortened as shown with the end of the torque tube 701 not at the edge of the solar module.

This may save material costs by allowing for a shortened torque tube that may support the same solar module to specifications. The shortened torque tube may weigh less than an extended torque tube, which may provide structural benefits, and/or save costs when transporting the torque tube. A lighter torque tube may enable a larger number of torque tubes to fit on a vehicle, and/or less gas to be expended for the same number of torque tubes. Furthermore, shortening the torque tube may enable to the torque tube to fit on a vehicle that may not be able to carry an extended torque tube. In one example, a shortened torque tube may fit on a standard flatbed vehicle while an extended torque tube may not. For example, the use of an outrigger extension may permit a 70 foot torque tube to be shortened to a 52 foot torque tube. A torque tube may be shortened from any dimension described herein to any other dimension described herein. This may simplify transport, and drive down costs associated with transport of the materials.

The outrigger extensions 730 may optionally be lighter than the additional length of torque tube 770. In some instances, the outrigger extensions may be easier to transport and/or manufacture than an extended torque tube. In some instances, the outrigger extensions may be more cost-effective than transporting and/or manufacturing an extended torque tube.

The use of separate outrigger extensions may permit the outrigger extensions to be formed from a different material than the torque tube. This may provide flexibility in selecting the outrigger extension materials to have desired characteristics.

The outrigger extensions may be arranged so that they are oriented at an angle relative to a longitudinal axis extending through a torque tube. The outrigger extensions may simultaneously provide support in a direction parallel and perpendicular to the longitudinal axis extending through the torque tube. This may result in not only a reduction of the torque tube length, but eliminate the need for one or more support that may have been provided at the end of the extended torque tube.

In a design with an extended torque tube and end supports, the end supports may result in only supporting half the weight that a middle support may support. This may provide unnecessary material needed to support the solar module. Using outrigger extensions may provide a way of using less material to support the solar module to specifications.

Outrigger extensions may reduce costs as opposed to a design with the extended torque tube. This may permit the overall system to be more market competitive without comprising structural requirements.

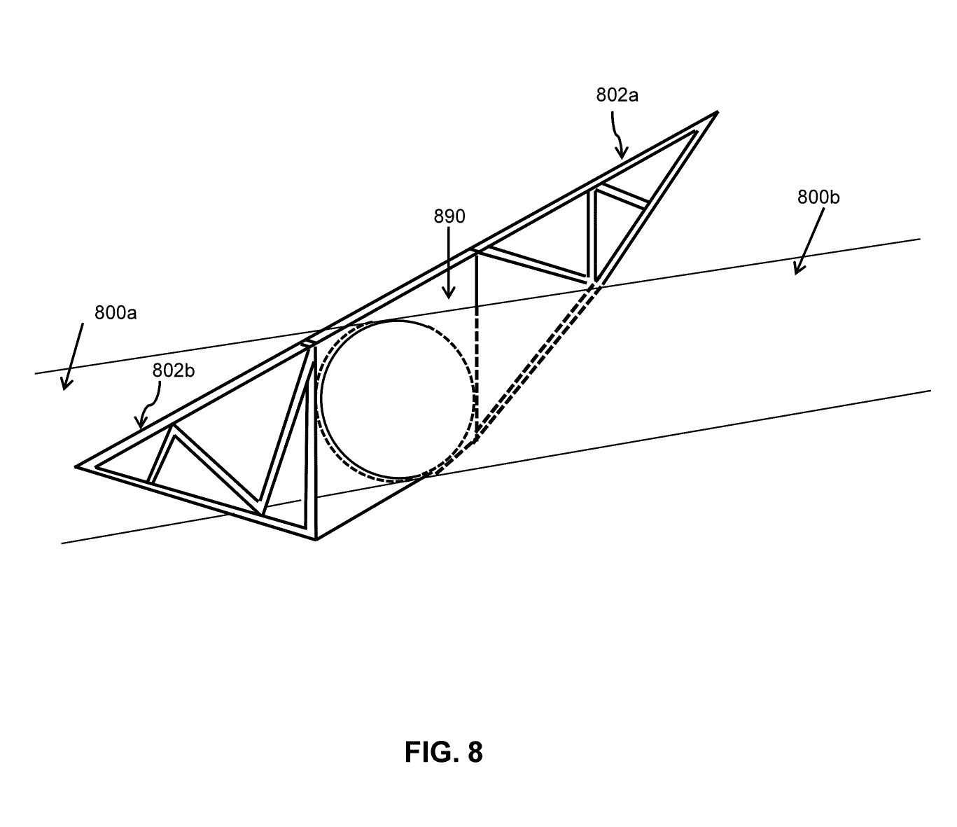

FIG. 8 shows an example of how the outriggers 802a, 802b may be affixed to a plate 890 that may separate portions of the torque tube 800a, 800b.

One or more outriggers 802a, 802b may be connected to a plate 890. In some instances two outriggers may be connected to the plate. The outriggers may be connected to the plate on opposing sides of the plate. The outriggers may be integrally formed on the plate. Alternatively, the outriggers may be permanently affixed to the plate. In some instances, the outriggers may be attached to the plate and may optionally be removable with respect to the plate. The outriggers may be symmetrically disposed on opposing sides of the plate.

The plate 890 may separate portions of the torque tube 800a, 800b. The plate may cut through the torque tube. Space within the portions of the torque tube may be separated by the plate. The plate may be a solid uninterrupted plate. The portions of the torque tube may be connected to the plate on opposing surfaces of the plate. The torque tube portions may be permanently affixed to the plates on opposing surfaces of the plates. Alternatively, they may be removably attached to the plates. In one example, the torque tube portions may be welded to the plates. The use of plates that may separate portions of torque tubes may provide ease of manufacturing for supports for the outriggers.

The plate may be formed of the same material as the torque tube, or a different material from the torque tube. The plate may be formed from the same material as the outriggers, or from different material as the outriggers.

In alternative embodiments, the torque tube may extend through an outrigger support structure. The outrigger support structure may be attached to an exterior surface of the torque tube. The torque tube may be uninterrupted.

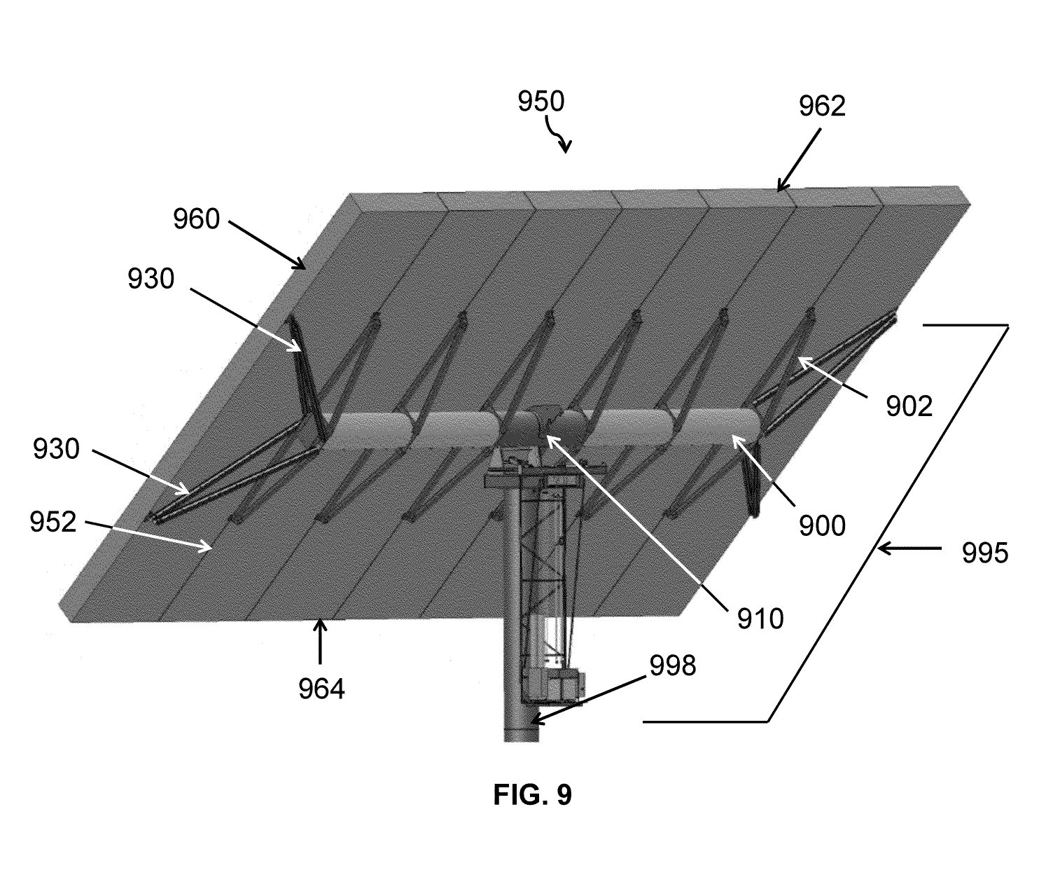

FIG. 9 shows a solar module 950, supported by a module support structure 995 with a torque tube 900 with longitudinal outrigger extensions 930. The module support structure may also include a support pedestal 998 or any other structure that may elevate the torque tube with respect to a surface. The surface can be the ground, or any building or infrastructure. The module support structure may also include one or more support outrigger 902. The support outriggers may be provided at intervals along the length of the torque tube.

The torque tube 900 may be connected to a support pedestal 998 via a torque tube rotation feature 910. The torque tube rotation feature may permit the solar module 950 to rotate with respect to the support pedestal. The torque tube rotation feature may permit the torque tube to rotate with respect to the support pedestal. The angle of the solar module may be varied, based on the actuation of a torque tube rotation feature. The angle of the solar module may be varied to track the sunlight and/or achieve a desired incidence with respect to the light emitted by the sun.

The module support structure 995 may support a solar module 950. The solar module may include a plurality of photovoltaic cells. The solar module may include a frame and/or support structure 952. The module support structure may hold up the weight of the solar module. The module support structure may be able to support the solar module to desired specifications. The module support structure may be configured to support the solar module while permitting the solar module to change position (e.g., tilt/rotate about the torque tube).

The solar module may be of a large weight. In some examples, the solar module may have a weight greater than, less than or equal to one or more of the following, and/or falling between two or more of the following: 0.1 tons, 0.3 tons, 0.5 tons, 0.75 tons, 1.0 tons, 1.2 tons, 1.5 tons, 1.7 tons, 2.0 tons, 2.2 tons, 2.5 tons, 3.0 tons, 3.5 tons, 4.0 tons, 4.5 tons, 5 tons, 6 tons, 7 tons, 8 tons, or 10 tons. The module support structure may be capable of supporting such a weight. The solar module may be a large-scale solar module.

The solar module may have any dimensions. In some embodiments, one or more dimensions of the solar module may be greater than, less than or equal to one or more of the following, and/or falling between two or more of the following: 1 m, 3 m, 5 m, 7 m, 10 m, 12 m, 15 m, 20 m, 25 m, 30 m, 35 m, 40 m, 45 m, 50 m, 60 m, 70 m, 80 m, 100 m, 120 m, 150 m, 200 m, 250 m, or 300 m. The dimensions (e.g., length, width, diameter, and/or diagonal) may be the same or may vary. The solar module may have any thickness, which may be greater than, less than or equal to one or more of the following, and/or falling between two or more of the following: 1 cm, 5 cm, 10 cm, 30 cm, 50 cm, 1 m, 3 m, 5 m, 7 m, 10 m, 12 m, 15 m, or 20 m.

The module support structure may be capable of supporting a solar module with such dimensions. In some instances, the module support structure may be capable of supporting such a solar module to desired specifications. In some instances, the desired specifications may include limiting the amount of deflection and/or bending by the solar module (e.g., max deflection less than 1/1500, 1/1000, 1/800, 1/700, 1/600, 1/500, 1/400, 1/350, 1/300, 1/250, 1/200, 1/150, 1/100, 1/75, 1/50, 1/30 for fraction of span). A max deflection for an outrigger may be less than or equal to about 1 inch, 0.5 inches, 0.3 inches, 0.2 inches, 0.1 inches, 0.80 inches, 0.075 inches, 0.07 inches, 0.065 inches, 0.06 inches, 0.055 inches, 0.05 inches, 0.045 inches, 0.04 inches, 0.035 inches, 0.03 inches, 0.02 inches, or 0.01 inches. The desired specifications may include a desired stiffness for the material, which may result in different max deflections, as described above. The desired specifications may further include a maximum stress for an outrigger of up to 30 ksi, 25 ksi, 20 ksi, 17 ksi, 15 ksi, 14 ksi, 13 ksi, 12 ksi, 11 ksi, 10 ksi, 8 ksi, 7 ksi, 5 ksi, 3 ksi, or 1 ksi.

In some other examples, the desired specifications may include permitting the solar module to be tilted to a desired angle or within a range of desired angles (e.g., completely horizontal, 5 degrees relative to horizontal, 10 degrees relative to horizontal, 15 degrees relative to horizontal, 20 degrees relative to horizontal, 30 degrees relative to horizontal, 45 degrees relative to horizontal, 60 degrees relative to horizontal, 70 degrees relative to horizontal, 75 degrees relative to horizontal, 80 degrees relative to horizontal, 85 degrees relative to horizontal, or 90 degrees relative to horizontal). In additional examples, the desired specifications may include rotating/tilting the solar module at a desired speed (e.g., at least 1 degree/minute, 3 degrees/min, 5 degrees/min, 10 degrees/min, 15 degrees/min, 20 degrees/min, 30 degrees/min, 45 degrees/min, 1 degree/sec, 3 degrees/sec, 5 degrees/sec, 10 degrees/sec, 15 degrees/sec, and/or 30 degrees/sec).

The support outriggers 902 of the module support structure may extend in a direction parallel to a frame portion 952 portion and/or edge 960 of the solar module. The support outriggers may be directed to a top edge 962 or bottom edge 964 of the solar module. The top edge and/or bottom edge may refer to edges of the solar module that are parallel to the longitudinal axis extending through a torque tube. The top edge may have a higher elevation than a bottom edge. If the top edge and bottom edge have the same elevation, either edge may be designated as the top edge and/or bottom edge.

A first support outrigger 902a may be directed to a top edge 962 and a second support outrigger 902b may be directed to a bottom edge 964. The support outriggers may or may not reach the edges to which they are directed. For example, the first support outrigger may or may not reach the top edge, and the second support outrigger may or may not reach the bottom edge. The ratio of the length of a support outrigger to the distance from the torque tube to the top or bottom edge of the solar module may be about 1:100, 1:70, 1:50, 1:30, 1:25, 1:20, 1:15, 1:12, 1:10, 1:8, 1:7, 1:6, 1:5, 1:4, 1:3, 1:2.5, 1:2, 1:1.5, 1:1.2, 1:1.1, 1:1, 1.1:1, 1.2:1, or 1.5:1. Each of the support outriggers may have the same length. Alternatively, each of the support outriggers may have varying lengths.

One or more longitudinal outrigger extensions 930 may be directed to a side edge 960 of the solar module. The longitudinal outrigger extensions may or may not reach the side edge to which they are directed. The ratio of the length of a longitudinal outrigger extensions to the distance from the torque tube to the side edge of the solar module may be about 1:100, 1:70, 1:50, 1:30, 1:25, 1:20, 1:15, 1:12, 1:10, 1:8, 1:7, 1:6, 1:5, 1:4, 1:3, 1:2.5, 1:2, 1:1.5, 1:1.2, 1:1.1, 1:1, 1.1:1, 1.2:1, 1.5:1, or any other ratio described elsewhere herein.

Examples showing a single torque tube are provided. Such systems and methods described herein may also include solar modules that are supported by two or more torque tubes. The systems and methods may utilize single axis tracking, two-axis tracking, and/or any other type of multi-axis tracking.

An outrigger may reach the edge of the solar module. Alternatively, the outrigger need not reach the edge of the solar module. The outrigger may be shorter than the length needed to reach the edge of the solar module. In other instances, the outrigger may extend past the edge of the solar module. The outrigger may be longer than the length needed to reach the edge of the solar module.

In some instances, systems may include a plurality of solar modules. One or more solar modules may be adjacent to one another. The solar modules may be arranged in rows and/or columns. The solar modules may be arranged as an array.

In some embodiments, an outrigger may support more than one module. For example, a second solar module may be adjacent to a first solar module. A first outrigger, extending past a torque tube of the first solar module and an edge of the first solar module, may also support the second solar module. The second module may or may not have a second outrigger that may extend past the edge of the second module and support the first module. Such outriggers may optionally overlap to support a plurality of solar modules. In some instances, the second module may not have an outrigger and/or torque tube and may be supported by outriggers from adjacent solar modules. The first outrigger may have a sufficient length to extend all along the length of the second, adjacent, solar module. Alternatively, the first outrigger may have a length that extends only part way along the second solar module, (e.g., ¾, ½, ¼ of the length of the second solar module). In another example, the first outrigger may extend beyond the length of the second solar module. The first outrigger may optionally support a third solar module, or any number of solar modules. Any combination of outriggers and lengths may be used. Adjacent solar modules may or may not contact one another. A gap may or may not be provided between adjacent solar modules.

One or more characteristics, components, features, and/or steps known in the art may be incorporated and/or used. See, e.g., U.S. Pat. No. 6,020,555; U.S. Pat. No. 8,026,440; U.S. Pat. No. 7,877,937; U.S. Pat. No. 6,248,949; U.S. Pat. No. 6,123,067; U.S. Pat. No. 6,559,371, which are hereby incorporated by reference in their entirety.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A solar arrangement comprising:
a solar module having a plurality of photovoltaic cells;
a torque tube, wherein an end of the torque tube does not extend to an edge of the solar module; and
at least one outrigger connected to the torque tube and the solar module, wherein the at least one outrigger extends beyond the end of the torque tube toward the edge of the solar module.

2. The solar arrangement of claim 1, wherein the solar module further comprises optics concentrating sunlight onto the plurality of photovoltaic cells.

3. The solar arrangement of claim 1, wherein the outrigger is formed with a truss-shape.

4. The solar arrangement of claim 1, wherein the outrigger is connected to the torque tube at or near the end of the torque tube.

5. The solar arrangement of claim 4, wherein a plurality of outriggers are connected to the torque tube at or near the end of the torque tube and extend beyond the end of the torque tube toward the edge of the solar module.

6. The solar arrangement of claim 1, wherein a length of the at least one outrigger is not perpendicular to a longitudinal axis of the torque tube.

7. The solar arrangement of claim 6, wherein the length of the at least one outrigger is not parallel to the longitudinal axis of the torque tube.

8. A method of supporting a solar module having at least one photovoltaic cell, said method comprising:
providing a torque tube that supports the solar module, wherein an end of the torque tube does not extend to an edge of the solar module; and
providing at least one outrigger connected to the torque tube and the solar module, wherein the at least one outrigger extends beyond the end of the torque tube toward the edge of the solar module.

9. The method of claim 8, wherein the solar module has a plurality of photovoltaic cells forming an array.

10. The method of claim 9, further comprising concentrating sunlight onto the plurality of photovoltaic cells via optics.

11. The method of claim 8, further comprising forming the outrigger with a truss-shape.

12. The method of claim 8, further comprising connecting the outrigger to the torque tube at or near the end of the torque tube.

13. The method of claim 12, further comprising connecting a plurality of outriggers to the torque tube at or near the end of the torque tube and extend beyond the end of the torque tube toward the edge of the solar module.

14. The method of claim 8, wherein a length of the at least one outrigger is not perpendicular to a longitudinal axis of the torque tube.

15. The method of claim 14, wherein the length of the at least one outrigger is not parallel to the longitudinal axis of the torque tube.

16. A solar arrangement comprising:
a solar module having a plurality of photovoltaic cells;
a torque tube, wherein a length of the torque tube along a longitudinal axis is less than a length of the solar module parallel to the longitudinal axis of the torque tube; and
at least one outrigger connected to the torque tube and the solar module, wherein the at least one outrigger extends beyond the end of the torque tube and is not perpendicular to the longitudinal axis of the torque tube.

17. The solar arrangement of claim 16 wherein the at least one outrigger has a first end connected to the torque tube and a second end that is closer to an edge of the solar module than the end of the torque tube.

18. The solar arrangement of claim 16 wherein a plurality of outriggers are connected to the torque tube at or near the end of the torque tube and extend beyond the end of the torque tube toward the edge of the solar module.

19. The solar arrangement of claim 18 wherein the plurality of outriggers are symmetrically positioned with respect to a plane through which the longitudinal axis of the torque tube extends.

20. The solar arrangement of claim 16 wherein the at least one outrigger contacts the solar module at multiple points.
